(19) United States
(12) Patent Application Publication
(10) Pub. No.: US 2018/0297392 A1
(43) Pub. Date: Oct. 18, 2018

(54) GENERATING MECHANICALLY RENDERED OBJECTS FROM DIGITAL INPUT

(71) Applicant: Sanford, L.P., Atlanta, GA (US)

(72) Inventors: Sandeep Caberwal, New York, NY (US); Samuel Joseph Broe, Brooklyn, NY (US); Anthony Scott O'Brien, New York, NY (US); Grant Kenji Larsen, Rhinecliff, NY (US)

(21) Appl. No.: 15/767,346

(22) PCT Filed: Oct. 13, 2016
(86) PCT No.: PCT/US16/56731

§ 371 Date: Apr. 10, 2018

Related U.S. Application Data
(60) Provisional application No. 62/242,108, filed on Oct. 15, 2015.

(51) Int. Cl. B43L 13/02; B43L 13/10

(52) U.S. Cl. CPC B43L 13/026; B43L 13/10

(57) ABSTRACT

Systems, methods, and computer-readable media are disclosed for generating mechanically rendered objects from digital input. In one embodiment, an example method may include generating, by a computer processor(s) coupled to at least one memory, a digital handwriting file comprising one or more digital characters, wherein a first digital character has a first glyph and a second glyph. Example methods may include receiving digital text comprising a set of characters for conversion to physically written text, wherein the set of characters comprises a first instance of a first character corresponding to the first digital character and a second instance of the first character, selecting the second glyph for a first physically written conversion of the first instance of the first character, selecting the first glyph for a second physically written conversion of the second instance of the first character, and causing conversion of the digital text.

### CROSS-REFERENCE TO RELATED APPLICATIONS

This application claims the benefit of U.S. Provisional Application No. 62/242,108, filed Oct. 15, 2015, which is hereby incorporated in its entirety by reference.

### BACKGROUND

Users may desire to generate physical objects from digital inputs. In one example, a user may want to draw a picture on an electronic display, and may desire a mechanically rendered object based on the drawing. In another example, a user may want to create multiple copies of a custom product, such as a handwritten letter, but may want the copies to also be handwritten. In some instances, the user may want variations between the copies, but the user may not want to handwrite the copies themselves. Accordingly, systems and methods for generating mechanically rendered objects from digital input may be desired.

### BRIEF DESCRIPTION OF THE DRAWINGS

FIGS. 1-2 depict a writing device for conversion of digital input to physical rendered objects in accordance with one or more embodiments of the disclosure.

FIG. 3 is an example process flow diagram for generating physical renderings from digital input in accordance with one or more embodiments of the disclosure.

FIG. 4 depicts an example physical rendered object generated from digital input in accordance with one or more embodiments of the disclosure.

FIG. 5 is an example process flow diagram for generating physical renderings from digital input in accordance with one or more embodiments of the disclosure.

FIG. 6 depicts example user interfaces for generating physical renderings from digital input in accordance with one or more embodiments of the disclosure.

FIG. 7 depicts example handwriting variances in accordance with one or more embodiments of the disclosure.

FIG. 8 schematically illustrates an example architecture of a computer system in accordance with one or more embodiments of the disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar but not necessarily the same or identical components; different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

### Overview

Embodiments of the disclosure may generate mechanically rendered objected from digital input. For example, certain embodiments may generate physical objects, such as cards or letters, that include written portions. The written potions may be written in ink or another medium, such as with a pen or a pencil, by a writing device that mimics human handwriting. In some instances, the writing device may mimic or adopt a handwriting style that is based on the user's own handwriting style. Written contents may be determined based at least on digital input from a user. The digital input may include text, images, drawings, or other input. The digital input may be typed in electronic form or may be written at a device display (e.g., on a touchscreen device, etc.). The writing device may produce replicas of an original sample and/or may produce physical objects with variations between one or more of the objects, so as to create an authentic handwritten look or appearance. Certain embodiments may be configured to use writing instruments, such as any type of pen or pencil, to generate writing that resembles handwritten content.

This disclosure relates to, among other things, systems, methods, computer-readable media, techniques, and methodologies for generating physical renderings from digital input. Digital input may be voice input, text input, drawing input, or other digital input. Embodiments may be configured to receive digital input and generate physical objects based at least in part on the input. The physical objects may include written portions that may be written by a writing device with the appearance of handwriting. In some instances, the writing device may produce physical objects that are identical to each other, while in other instances, the writing device may product physical objects that are different from each other. For example, the writing device may write “thank you” cards with written portions. While all of the “thank you” cards may optionally have the same textual content, apart from an addressee, the cards may have one or more variations between the cards so as to create an authentic handwritten appearance. For example, a first card may have a slight line skew, or a first kerning between the letters “w” and “e,” while a second card may not have the line skew and may have a second kerning between the letters “w” and “e” that is different than the first kerning of the first card. In another example, certain cards produced by embodiments may have the same message content, while certain aspects of the cards may be different (e.g., variations in writing, etc.). The differences may not only include differences in placement of writing on a card, but also could be differences between different instances of the same letter or combination of letters (e.g., “w” in one word is different from “w” in another word, or “tt” is different between cards, etc.).

Embodiments of the disclosure include writing devices that may be configured to generate writing that appears handwritten by a human, user interface components that allow users to enter digital input, and other components to facilitate conversion of digital input to physical objects that may include written portions.

Systems, methods, and devices for generating mechanically rendered and/or scripted objects (e.g., handwritten cards or notes) based on digital input, such as input received from users, are described. Such systems provide a technological environment and various digital services that support meaningful, directed, and physical interactions between people. For example, the systems and methods described herein may create unique, original, personalized correspondence for people, such as their friends, family, colleagues, and so on, among other benefits. Embodiments of the disclosure may generate unique, customized, mechanically handwritten cards and other objects in response to requests from users, such as requests that include samples of user handwriting styles.

A user device, such as a mobile device, smart phone, tablet computer, laptop, personal computer, and so on, may access, via a mobile application or directed web browser, an online site or portal provided by a user experience system that is hosted by an operations server. The user device may communicate with the operations server over a network, such as a wireless network, telecommunications network, and so on. For example, the user experience system may interact with the mobile application or web browser to display pages of content to the user and/or receive input from the user, such as user selections of displayed content, scanned handwriting samples, and so on.

In some embodiments, a card generation system receives or otherwise accesses user input, such as handwriting samples provided by the user, and performs various processes to generate a style or font that represents the user input handwriting sample, and/or generate a render (e.g., a message rendered in the generated style or font) to be sent to one or more handwriting machines that mechanically-render the generated render to a physical object, such as a paper card or other flat object. For example, the operation server may provide a render file of the render to a machine server, which communicates with and/or controls one or more networked handwriting machines. The handwriting machines mechanically-render the message onto target objects, such as paper cards.

The user experience system may enable users to navigate various templates associated with the creation, generation, selection, and/or modification of greeting cards and/or other mechanically-rendered objects. The user experience system enables, among other things, the user-selection and/or customization of stationery or card styles, configurations and/or layouts, the input of text or other messages, including the selection and/or upload of various handwriting styles or fonts, the selection, generation, and/or discovery of recipient addresses, the review and confirmation of input information, and/or the ordering and/or purchasing of products and services, such as mechanically or physically rendered cards or stationery based on the digital input and selections provided by the user. The user experience system may render and/or display other user interfaces, information, and so on. In some embodiments, the user experience system provides users with automatic discovery and retrieval of user recipient addresses, and/or provides users with management of user addresses. For example, aspects of the user experience system, and/or a standalone service, may facilitate the linking of personal data between a requester and a requestee.

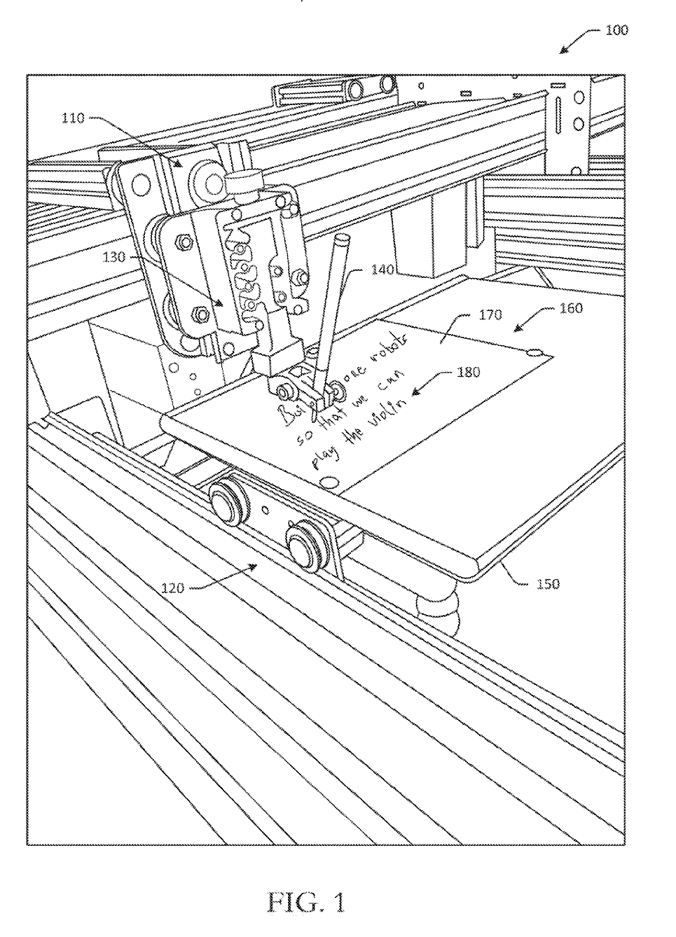

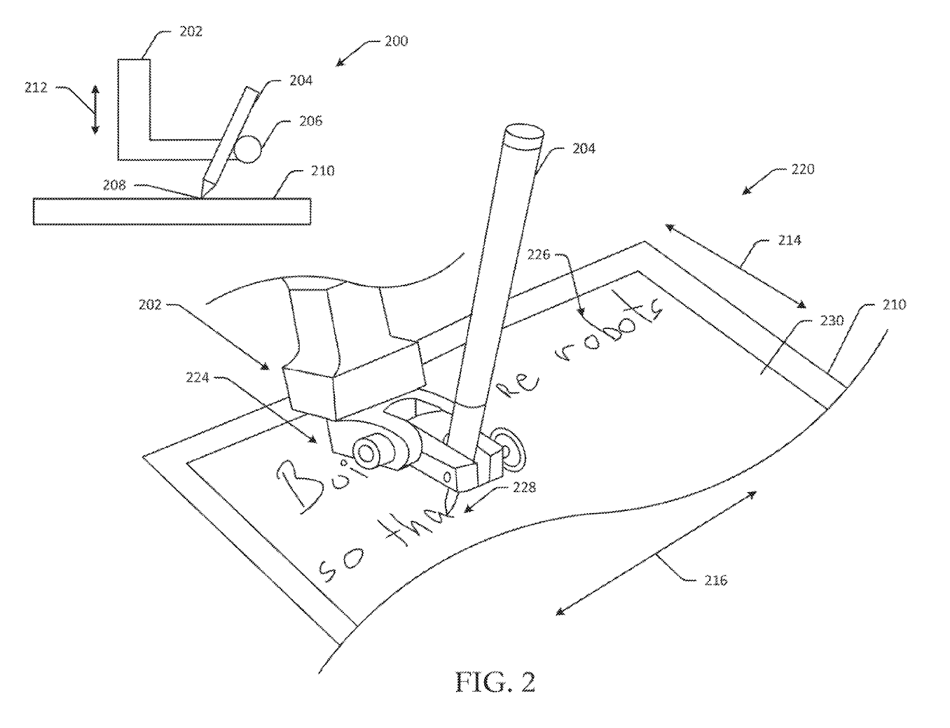

Referring to FIGS. 1-2, an example writing device 100 for conversion of digital input to physical rendered objects in accordance with one or more embodiments of the disclosure is depicted. The writing device 100 may be a mechanical drawing apparatus or a mechanical device configured to generate written content. In some embodiments, the writing device 100 may use writing instruments such as pens, pencils, markers, and other instruments to generate written content, while in other embodiments, the writing device 100 may use ink or other fluid, for example, in a reservoir to generate written content, and in yet other embodiments the writing device 100 may include an instrument which mechanically, digitally, or in other ways alters an object (including without limitation inscription, engraving, capacitive or resistive touchscreen manipulation, and the like). Function of the writing device 100 may be controlled by a local or remote controller device.

The writing device 100 may include one or more moving components that may move via any number of motors, gears, pulleys, and the like. The writing device 100 may move components so as to generate written content. In the example of FIG. 1, the writing device 100 may include one or more movable portions, such as a writing instrument carrier 110, an object holder 120, and/or other movable portions.

The writing instrument carrier 110 may be configured to hold, secure, grip, or otherwise receive a writing instrument 140. The writing instrument carrier 110 may be configured to move the writing instrument 140 so as to generate written content using the writing instrument. The writing instrument carrier 110 may be configured to move in one or more directions, such as in an X, Y, and/or Z direction. Accordingly, the writing instrument carrier 110 may be configured to draw or write using the writing instrument 140 at a first line, and then move in the Y direction to a second line. The writing instrument carrier 110 may move in the Z direction in between writing characters, for example. In other embodiments, the object holder 120 may move instead of, or in addition to, the writing instrument carrier 110. The writing instrument carrier 110 may move along a single axis, two axes, or three or more axes in different embodiments.

The object holder 120 may be any suitable platform, such as the illustrated example flat surface 150, that is configured to receive an object. For example, the object holder 120 may receive paper, cards, foam, and other objects that may be written on, inscribed, or otherwise mechanically altered, with the writing instrument 140. In some embodiments, the object may have a writing surface. For example, in FIG. 1, the object holder 120 may receive an object such as a card 160 that is placed on and/or secured to the flat surface 150 of the object holder 120. The card 160 may have a writing surface 170 that can be used to write on with the writing instrument 140. The object holder 120 may configured to move the object in one or more, or at least two, directions, such as an X, Y, and/or Z direction. The object holder 120 may move along a single axis, two axes, or three or more axes in different embodiments.

The writing instrument 140 may include a writing portion or writing tip that may be positioned at an end of the writing instrument 140. The writing tip may be configured to write on objects, such as the writing surface 170 of the card 160. The writing instrument 140 may be positioned in the writing instrument carrier 110 and may be used by the writing device 100 to generate written content 180. For example, in FIG. 1, the writing device 100 may generate written content 180 that says “Build more robots so that we can play the violin.” The written content 180 may resemble handwriting rather than a computerized font or computer-generated output.

In some embodiments, the writing device 100 may include a calibration mechanism to regulate and/or calibrate a pressure between the writing tip of the writing instrument 140 and the flat surface 150 or platform of the object holder 120. For example, the writing device 100 may include one or more pressure sensors positioned at the object holder 120 and/or at the writing instrument carrier 110. The pressure sensor may be configured to detect a pressure between the writing tip and the object holder 120, and the writing device 100 may adjust a positioning of either or both the writing instrument (or the writing instrument carrier) or the object holder 120 if the detected pressure is too high or too low. For example, if the detected pressure is greater than a predefined acceptable pressure range, the writing instrument carrier may be adjusted so as to move the writing instrument further away from the object holder, thereby reducing the pressure.

In certain embodiments, the writing device may determine that a first pressure value between the writing tip and the object holder is less than a predetermined pressure value. The writing device may adjust a first position of the writing instrument carrier or a second position of the object holder, until it is determined by the writing machine that a second pressure value between the writing tip and the object holder is substantially equal to the predetermined pressure value. In some embodiments, the pressure between the writing device and the object holder may be parametrically varied to add an authenticity to the appearance of the physically written content.

Some embodiments of the writing device 100 may include an electrostatic generator that can generate an electrostatic charge that can be used to hold the object 160 in place while the writing device is writing. For example, the electrostatic generator may be coupled to the object holder 120, and may be configured to generate an electrostatic charge at one or more surfaces of the object holder 120. The electrostatic charge may be used to attract the object 160 and hold the object 160 in place during writing, as needed. The electrostatic charge can be reversed or reduced to release the object 160 after completion.

FIG. 2 illustrates a side view 200 of another writing device. The writing device may include a writing instrument carrier 202 that holds or receives a writing instrument 204. The writing instrument carrier 202 may include a knob, latch, or other mechanism that can be used to remove the writing instrument 204 from the writing instrument carrier 202. The writing instrument carrier 202 may have a compliant portion that allows for compliance between the writing instrument 204 and an object holder 210 and/or the writing instrument carrier 202. The writing instrument 204 may include a writing instrument tip 208 that can he used to write on an object at the object holder 210. The writing instrument carrier 202 may be configured to move in a Z direction 210, as well as an X direction 216 and/or a Y direction 214.

In a perspective view 220 of the writing device of FIG. 2, the object holder 210 may also move in one or more of the Z direction 210, X direction 216, and/or the Y direction 214. The writing device may be using the writing instrument 204 to write on a card 230. A compliant portion 224 of the writing instrument carrier 202 may allow for flex or resilience during the writing process. The writing device may generate written content at a first line 226, and may generate a second line 228 of written content by guiding the writing instrument 204 along a path that forms one or more characters across portions of the card 230, such as in a path similar to the manner by which a human handwrites the same content, while a portion of the writing instrument, such as a tip, is in contact with the card 230, thereby leaving ink where the tip is in contact with the card 230. As the tip is dragged or guided along certain paths, a desired character may be formed on the card 230. In FIG. 2, the writing device is in the process of writing an “a” character by moving the writing instrument 204 along a predefined path.

The systems, methods, computer-readable media, techniques, and methodologies for generating physical renderings from digital input may generate physical objects, such as written content that resembles handwriting, from digital input. Users may input digital text, or may handwrite content that can be converted from a digital format to a physical format via the use of writing devices.

Example embodiments of the disclosure provide a number of technical features or technical effects. For example, in accordance with example embodiments of the disclosure, certain embodiments of the disclosure may generate written content with the appearance of handwriting, and can generate paths and sequences that resemble a handwriting style, as opposed to traditional printing of computer fonts or photocopies. The above examples of technical features and/or technical effects of example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative Processes and Use Cases

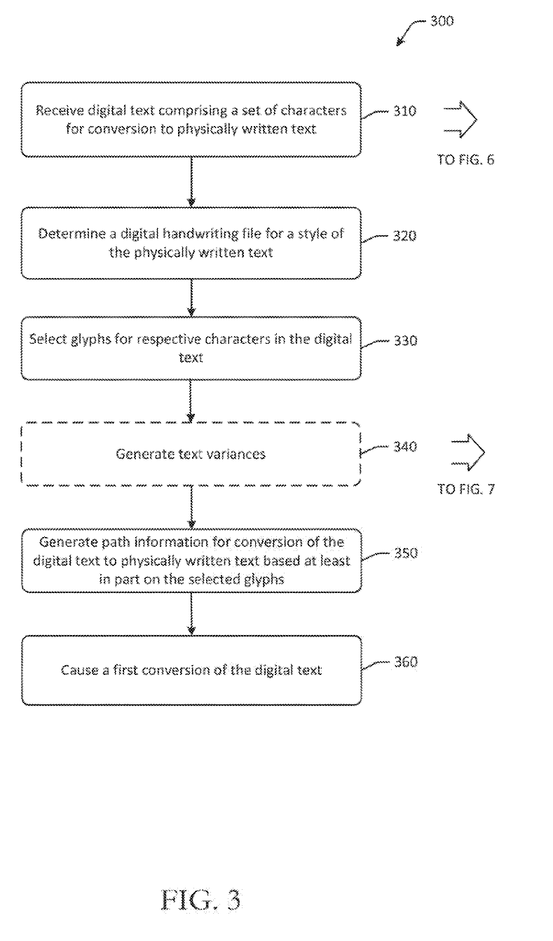

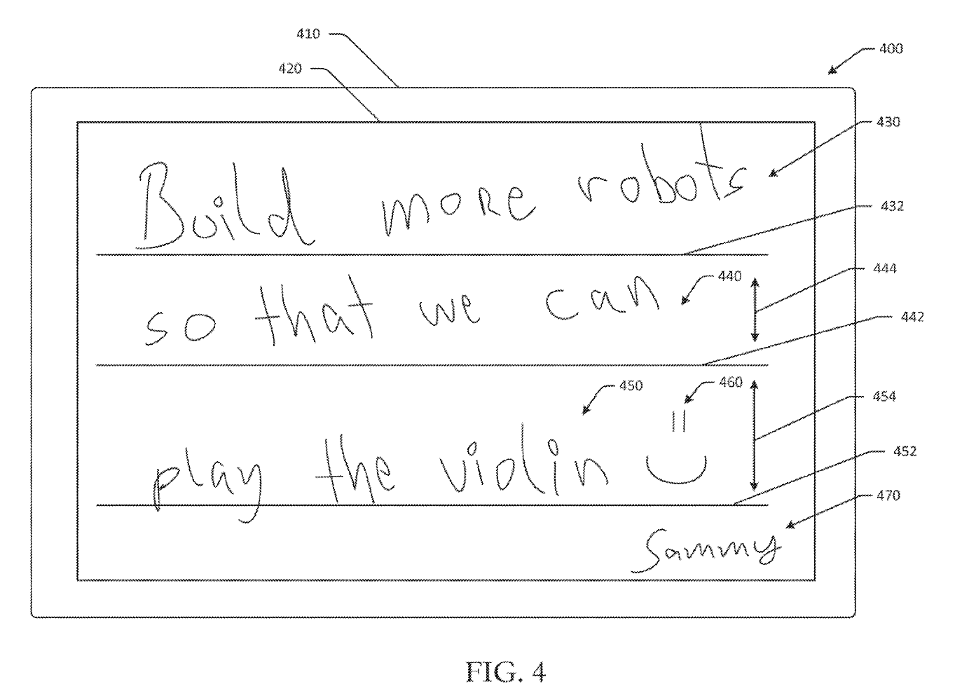

Referring to FIG. 3, an example process flow 300 for generating physical renderings from digital input in accordance with one or more embodiments of the disclosure is depicted. Although certain operations are illustrated as occurring separately in FIG. 3, some or all of the operations may occur concurrently or partially concurrently across one or more computer systems. FIG. 4 depicts an example physical rendered object generated from digital input in accordance with one or more embodiments of the disclosure and will be discussed in conjunction with FIG. 3.

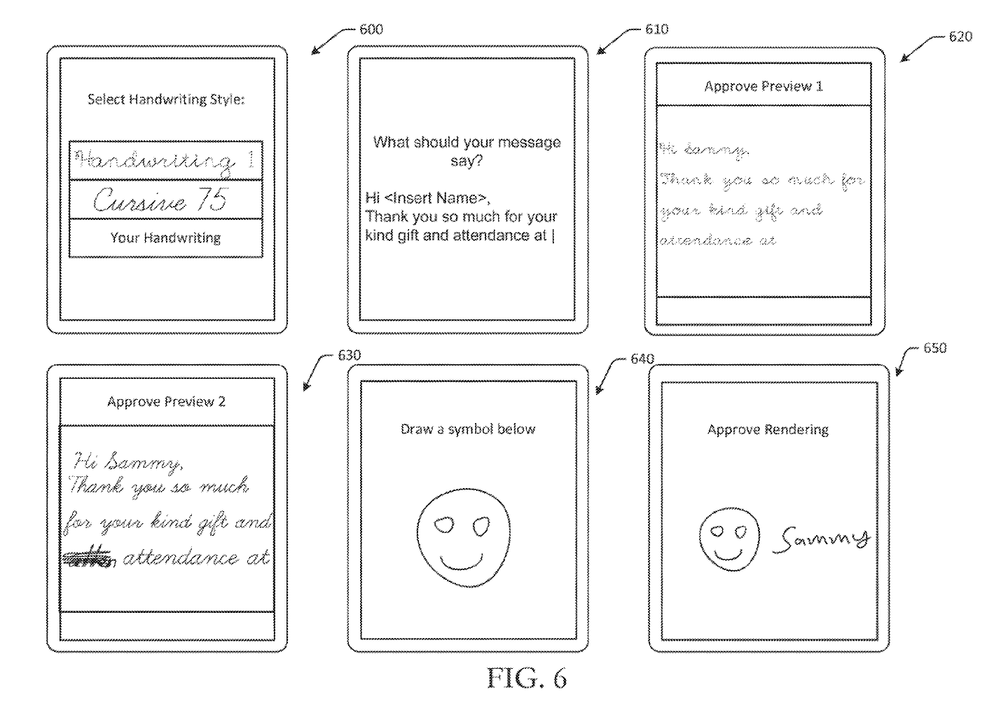

At a first operation 310 of the process flow 300, digital text comprising a set of characters for conversion to physically written text is received. In one example, a remote server may receive digital text or other writing in a text message (e.g., from a mobile device), a spreadsheet, an email message, and the like. For example, a user may interact with one or more user interfaces to input digital characters, text, images, drawings, or other digital inputs for conversion to physical writing. For example, a user may interact with a mobile application or a web-based interface to input a set of characters for conversion. The user may select a handwriting style and/or select a digital handwriting file that is to be used for the conversion. In some instances, the user may desire an exact replica of a digital input instead of a handwriting style (e.g., a smiley face or a custom symbol, etc.). FIG. 6 depicts example user interfaces that allow a user to input text and/or other content for conversion to physical writing, as well as selection of a handwriting style.

At a second operation 320 of the process flow 300, a digital handwriting file for a style of the physically written text may be received. The digital handwriting file may include information related to one or more characters, symbols, drawings, and the like, and may be associated with a particular user and/or user account. For example, the one or more remote servers may determine a digital handwriting file for a style of the physically written text. In some instances the digital handwriting file may be determined based at least in part on the user's selection of a digital handwriting file, while in other instances the digital handwriting file may be identified or determined based at least in part on the user's selection of a digital handwriting style or other user preference.

The digital handwriting file may be generated based at least in park on a writing sample of handwriting provided by a human. Characteristics of the human handwriting may be derived from the writing sample, such as sequence of formation of characters, gaps between characters, naturally occurring variances in handwriting, line skew, baseline variation, and other characteristics. The digital handwriting file may be generated for use by the human or another user and may include unique and/or custom generated glyphs that can be used for physically written content. The glyphs may be stored in the digital handwriting file.

The digital handwriting file may include one or more glyphs for various characters in the alphabet, as well as for symbols, drawings, emoticons, etc. In some embodiments, the digital handwriting file may include multiple glyphs for one or more, or each, respective character in the alphabet. The digital characters received from the user may correspond to characters in the digital handwriting file. The digital handwriting file may include path information that can be used to draw or write a specific glyph of a character. The path information may be sent to a writing device for conversion of a digital character to a written glyph. In one example, the digital handwriting file may include a first glyph and a second glyph of a first digital character corresponding to a first character of “a” in the digital text.

At a third operation 330, glyphs for respective characters in the digital text may be selected. For example, the digital handwriting file may include multiple glyphs for the character “a” and the remote server may select and/or assign the same or different glyphs to the respective “a” characters that appear in the digital text.

A specific glyph may be assigned to each instance of a character. For example, the second glyph may be selected for a first physically written conversion of the first instance of the first character, and the first glyph may be selected for a second physically written conversion of the second instance of the first character, or vice versa.

For characters with multiple glyphs, glyphs to use for specific instances of characters may be randomly selected, selected in succession or in a cyclical order, selected by a user, or selected in another suitable manner. Accordingly, two or more instances of the same character may not look exactly the same when converted to physical writing.

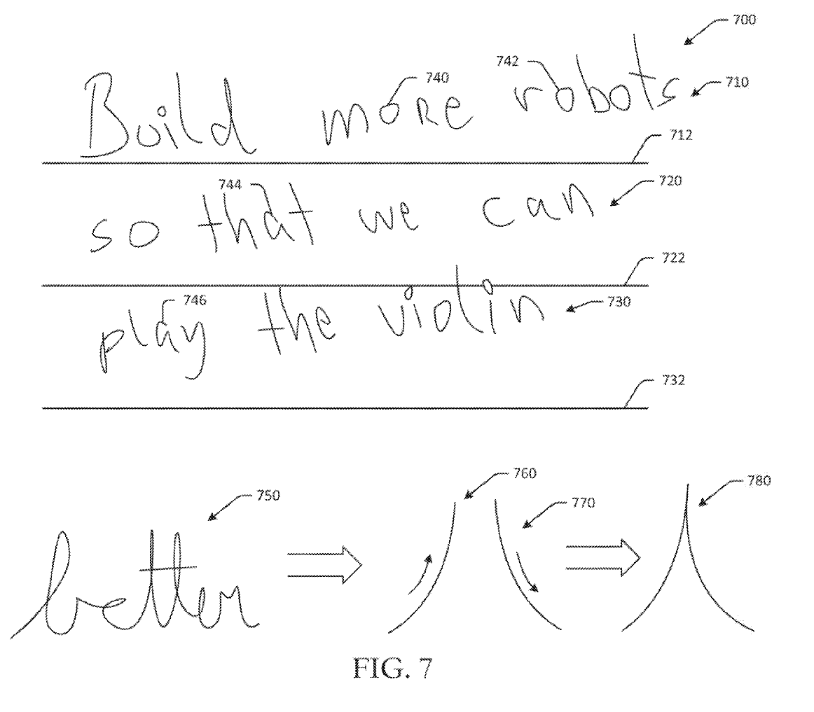

At optional fourth operation 340, text variations may be generated. Text variations may be repeatable or non-repeatable differences or variations between the same characters or words either within a single conversion or product, or between two or more conversions or products. For example, comparing two conversions side by side may allow a user to detect nuances or differences between the writing, thereby providing an authentic handwritten appearance. FIG. 7 depicts example text variances.

At a fifth operation 350, path information for conversion of the digital text to physically written text based at least in part on the selected glyphs is generated. In one example, the remote server may generate path information that can be used and/or implemented by the writing device to convert the digital text to physically written text. The path information may account for the selected and/or assigned glyphs for the respective characters in the digital text.

At a sixth operation 360, a first conversion of the digital text may be caused. The first conversion may be of the digital text to physically written text. The writing device may the first physically written text. In some embodiments, the conversion may be caused by the writing device, while in other embodiments, the conversion may be caused by one or more remote servers. To cause the conversion of the digital text to physically written text, path information for one or more of the set of characters may be generated by and/or communicated to the writing device. The path information may be generated based at least in part on the specific glyphs, if any, assigned to the respective characters that are to be converted. Path information may include a sequence of one or more specific paths for respective glyphs that can be used to convert the digital text or writing to physical writing. The writing device can move the writing instrument along the path to form the respective glyph. The path information may include starting locations for lines, origins for glyphs, and other information. Path information may be generated manually or automatically. For example, path information may be generated by a human manually tracing or writing characters, where the manual movement is tracked and stored as path information associated with a certain character. Path information may be generated automatically, for example, via optical character recognition or another software-based process of extracting writing data from a handwriting sample, and generating vector data based on the extracted writing data that can be sequenced into path information.

The path information may be sent to one or more writing devices for conversion of the digital text to the physically written text. In instances where multiple conversions are desired, a first conversion may be produced at a first writing device, and a second conversion may be produced at a second writing device, or both conversions may be produced by the same device.

In instances where multiple conversions are desired, the multiple conversions may be replicas of each other, or one or more of the multiple conversions may be different from each other. For example, a first conversion of the digital text to first physically written text may appear different than a second conversion of the digital text to second physically written text. Specifically, the first physically written text may be different than the second physically written text.

To convert the digital text or content to physically written text or content, the writing device may receive path instructions. The path information may include data related to one or more paths about which to move the object holder, the writing instrument carrier, and/or the writing instrument. For example, the one or more paths may include a first path at a first line and a second path at a second line. The path information may include starting locations for lines, origins for glyphs, and other information.

Based at least in part on the path information, the writing device may identify a first starting location of the first line at the writing surface. The writing device may position the writing instrument at the first starting location.

The writing device may optionally determine that a writing tip of the writing instrument is in contact with the writing surface, and may move or otherwise guide the object holder or the writing instrument carrier along the first path. The writing device may complete the first path, and may move the object holder or the writing instrument to create a gap between the writing tip and the writing surface. For example, the writing device may lift the writing instrument away from the object holder and the writing surface so as to avoid stray marks. The writing device may identify a second starting location of the second line, and may bring the writing tip in contact with the writing surface. The writing device may optionally determine that the writing tip is in contact with the writing surface, and may move the object holder or the writing instrument carrier along the second path. The aforedescribed manner of operation provides for a realistic simulation of handwriting by generating path data, and executing path instructions by the writing device in much the same manner that a human would handwrite the same content. In some embodiments, the output of the writing device may be generated at a speed significantly faster than human writing, while in other embodiments, the output of the writing device may be generated at a speed resembling human writing, so as to add to the authentic appearance of the output.

In the example of FIG. 4, an example use case 400 of an object holder 410 with a card 420 positioned on the object holder 410 is depicted at a writing device. The writing device may have written the first physically written text of FIG. 3 on the card 420. The remote server and/or the writing device may have received digital text such as “Build more robots so that we can play the violin [symbol] ”. The digital text may include a set of characters for conversion to physically written text. The set of characters may include multiple instances of the same character, such as a number of lowercase “o” characters. For example, in FIG. 4, digital text may be received that includes a first instance of a first character lowercase “o” and a second instance of the first character lowercase “o” in the word “robot”. There may be other instances of the lowercase “o” as well, as well as other characters that occur a number of times. The remote server and/or the writing device may select and/or assign glyphs to the respective instances of the characters, so that the characters may look the same or different. In the example of FIG. 4, the word “robot” may include two different glyphs for “o” such that the second “o” appears larger than the first “o” and has a different geometric shape. Accordingly, in some embodiments, rather than a single set of multiple glyphs used to generate a unique inscription, multiple handwriting files, each with variation therein, may be used to create a unique and coherent handwriting style for each handwriting file.

The physically written text in FIG. 4 may include a first line of written content 430 positioned along a first baseline 432, a second line of written content 440 positioned along a second baseline 442, and a third line of written content 450 positioned along a third baseline 452. The respective baselines may have the same distance between them, or may have varying distances. For example, a first gap 444 or distance between the first baseline 432 and the second baseline 442 may be the same or different than a second gap 454 or distance between the second baseline 442 and the third baseline 452. The first gap 444 and/or the second gap 454 may be determined based at least in part on the user's own handwriting style, or may be generated and/or adjusted so as to create variances within the card 420 or between multiple cards.

After a glyph is drawn, the writing device may move to a subsequent glyph. In sonic embodiments, the writing device may be configured to calibrate a distance between the writing tip and the writing surface before moving the object holder or the writing instrument carrier along a second path for the subsequent glyph. For example, the writing device may lift the writing instrument away from the card, or move the card away from the writing instrument, so as to avoid connecting adjacent glyphs or generating stray marks.

The digital text for conversion may include non-character content that may also be converted to physically written content. For example, the digital text may include a smiley face or another drawing that is converted to a physically written smiley face 460, as well as a custom signature that may converted to a physically written signature 470. Path information for the non-character content may be based at least in part on the user's input (e.g., a sequence of movements that the user performed to generate the non-character content, etc.), and/or may be generated based at least in part on an analysis of a completed input or sample provided by the user.

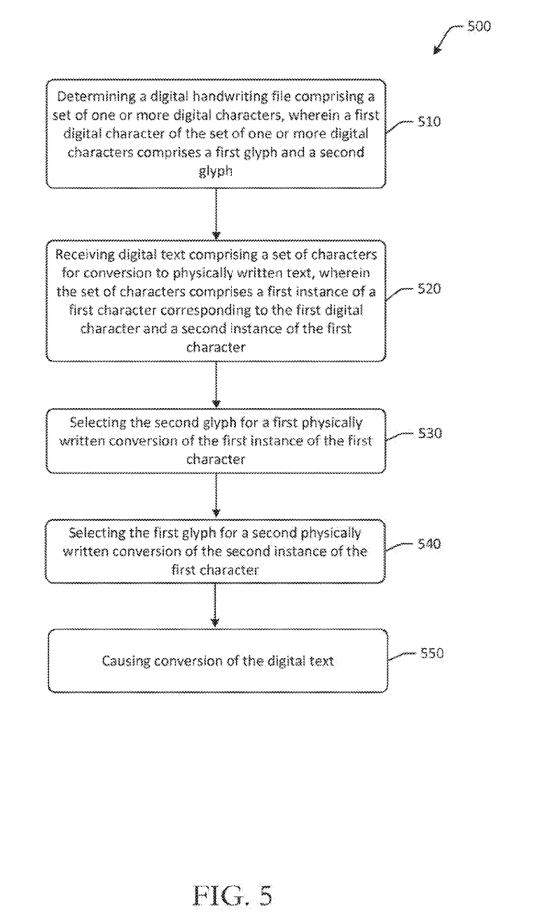

FIG. 5 is an example process flow 500 diagram for generating physical renderings from digital input in accordance with one or more embodiments of the disclosure. The operations of FIG. 5 can be performed in any order, concurrently, and/or partially concurrently. FIG. 6 depicts example user interfaces for generating physical renderings from digital input in accordance with one or more embodiments of the disclosure and will be discussed in conjunction with FIG. 5.

At a first operation 510, a digital handwriting file including a set of one or more digital characters may be determined or retrieved, where a first digital character of the set of one or more digital characters has a first glyph and a second glyph. In some embodiments, the digital handwriting file may be generated. The digital characters may be letters or characters that can be digitally rendered and/or presented at a display. The glyphs may be an appearance of the digital character. For example, the same uppercase “A” digital character may have a first glyph of a first appearance and size, as well as a second glyph of a second appearance and size different from the first glyph. The digital handwriting file may include path information for multiple vectors and/or coordinate information that can be used by the writing device to produce written content.

Certain embodiments may generate custom digital handwriting files for specific user's handwriting, such that the user can have digital text converted to physical writing that matches the user's own handwriting. The digital handwriting file may include a set of one or more digital characters, as well as one or more, or multiple, glyphs for each character.

At FIG. 6, a first user interface 600 may provide selectable options for a user to select a handwriting style. The first user interface 600 may be presented at any electronic device, such as a mobile device, laptop, computer, or other device. The handwriting styles may include any number of handwriting styles, include the user's own handwriting style.

At a second operation 520 in FIG. 5, digital text comprising a set of characters for conversion to physically rendered text may be received, where the set of characters includes a first instance of a first character corresponding to the first digital character and a second instance of the first character.

In FIG. 6, a second user interface 610 illustrates user input of digital text. The user may type, dictate, speak, or otherwise input digital text at the user device. For example, the digital text may include a set of characters forming the phrase “Hi [Name of recipient can be automatically inserted so the same message can be sent to multiple recipients], Thank you so much for your kind gift and attendance at”. The set of characters may include a first instance, for example, of “u” and a second instance of “u” in the words “you” and “much”.

In one embodiment, the digital input may be received, for example, at a text renderer module, that converts the digital input to a scalable vector graphic that is presented at the user device. The text renderer module may generate scalable vector graphics until one or more outputs are approved for conversion to physical writing.

At a third operation 530 of the process flow 500, the second glyph may be selected for a first physically written conversion of the first instance of the first character. At a fourth operation 540, the first glyph may be selected for a second physically written conversion of the second instance of the first character. In FIG. 6, accordingly, one glyph may be selected for the “u” in “you,” while another glyph may be selected for the “u” in “much” so that the two “u” characters appear different.

At a fifth operation 550, conversion of the digital text may be caused. The conversion may be of the digital text to physically written text. For example, a remote server may send instructions to a writing device comprising path information that can be executed by the writing device to physically write the digital text.

In FIG. 6, the user may have an opportunity to review and/or approve an appearance of the physically written content before the writing device initiates the conversion. For example, at a third user interface 620, the user may be presented an example rendering of what the physically written content would look like, and can approve or reject it. If the user rejects the written content appearance at the third user interface 620, a fourth user interface 630 may be presented with another rendering of the physically written content. The rendering at the fourth user interface 630 may include intentional errors, like a crossed out word, to add to the authentic nature of the written content. The user can approve or reject the writing, and an iterative process can be completed with variations between the renderings until the user approves at least one rendering. In some instances, the user may approve multiple renderings that can all be converted to physical writing.

At a fifth user interface 640, the user may draw a custom symbol that can he converted to physically written content. For example, the user may draw a smiley face, a logo, a signature, or other non-text content that can be converted to written content by the writing device. The sequence of inputs that the user makes may be monitored and/or stored so as to recreate the digital input as physical content. At a sixth user interface 650, a rendering of an appearance of the custom symbol may be presented for approval and/or modification. If the user approves the rendering, the writing device may convert the digital input to written content. In some embodiments, the user may not need to approve the appearance.

FIG. 7 depicts example handwriting variances for written content 700 in accordance with one or more embodiments of the disclosure. Certain embodiments may generate handwriting variances to create differences between two different physical writing conversions of the same digital input. Variances include, but are not limited to, line gap variations, amplitude variations, line slope and/or waver variations, sine curve variations, baseline variations, kerning and/or character gap variations, character size variations, and/or indent variations.

The written content 700 may include a first line 710, a second line 720, and a third line 730. Each line may have the same or different line gap variations, amplitude variations, line slope and/or waver variations, sine curve variations, baseline variations, kerning and/or character gap variations, character size variations, and/or indent variations.

A baseline variance may be used to vary distances between two baselines of different lines of text. Baseline variances may be applied to a single physical writing (e.g., three lines of text may have a different gap between the first line and the second line, than a gap between the second line and a third line, etc.), or to two different conversions of physical writing, such that the line gaps are at least partially different between the two conversions. To generate a baseline variance, in one example, embodiments of the disclosure may determine that the digital text includes first text on a first line, second text on a second line, and third text on a third line. A first distance between respective baselines of the first line, the second line, and the third line may be adjusted, such that a first distance between a first baseline of the first line and a second baseline of the second line is different than a second distance between the second baseline of the second line and a third baseline of the third line. In the example of FIG. 7, a distance between a first baseline 712 and a second baseline 722 may be the same or different than a distance between the second baseline 722 and a third baseline 732.

A kerning and/or character gap variance may be used to vary distances between two characters adjacent to one another. For example, if the word “we” appears twice in the text, then a distance between the “w” and the “e” may be different for the two instances of “we” so as to create a natural handwriting appearance of the physically written content. Kerning and/or character gap variances may be applied to a single physical writing, or to two different conversions of physical writing. For example, another conversion of the same text could have a different character gap between the “w” and the “e” so that the conversions do not look exactly the same. To generate a kerning and/or character gap variance, in one example, certain embodiments may determine that the digital text includes a first instance of a second character adjacent to the first instance of the first character, and that the digital text comprising a second instance of the second character adjacent to the second instance of the first character. A distance between the respective instances of the first character and the second character may be adjusted, such that a first distance between the first instance of a second character and the first instance of the first character is different than a second distance between the second instance of the second character and the second instance of the first character.

A baseline height variance may be used to vary distances between a bottom of characters or words and the baseline. For example, some characters and/or words may be written along the baseline, while other words may be written above or below the baseline, so as to make the writing non-uniform along the baseline. In one example, if the word “we” appears in the text, then a distance between the “w” and the baseline may be different than a distance between the “e” and the baseline. In another example, the distance between the word “we” and the baseline at a first conversion may be different than a distance between the word “we” and the baseline at a second conversion or at a second instance of the word “we.”

Baseline height variances may be applied to a single physical writing, or to two different conversions of physical writing. To generate a baseline height variance, in one example, certain embodiments may determine that the first instance of the first character and the second instance of the second character are on a first line, and may adjust a distance between bottoms of the respective instance of the first character and a baseline of the first line, such that a first distance between a first bottom of the first instance is different than a second distance between a second bottom of the second instance. In the example of FIG. 7, the word “Build” may be positioned at the first baseline 712, while the word “robots” may be positioned further away from the first baseline 712. Similarly, a first instance 740 of “o” may be positioned a first distance from the first baseline 712, while a second instance 742 of “o” may be positioned a second distance from the first baseline 712.

A line skew variance may be used to vary an angle of a word or a line of text within a single conversion, or between multiple conversions. To generate a line skew variance, in one example, certain embodiments may determine that the digital text has a first line and a second line, and may adjust a line skew amplitude of the first line and the second line, such that a first line skew amplitude of the first line is different than a second line skew amplitude of the second line. The lines may therefore, have different slopes. In other instances, the line slopes of the same line may be different between two conversions. The first line 710 may have a first line skew, while the second line 720 may have the same or a different line skew, and the third line 730 may have the same or different line skew.

A line waver variance may be used to vary a waver frequency of a word or a line of text within a single conversion, or between multiple conversions. To generate a line waver variance, in one example, certain embodiments may determine that the digital text has a first line and a second line, and may adjust a line waver frequency of the first line and the second line, such that a first line waver frequency of the first line is different than a second waver frequency of the second line. The first line 710 may have a first line waver, while the second line 720 may have the same or a different line waver, and the third line 730 may have the same or different line waver.

A character size variance may be used to vary character size of a character that appears at least once within a single conversion, or between multiple conversions. To generate a character size variance, in one example, certain embodiments may determine a first character size for a first glyph of a character, and may determine a second character size for a second glyph of the character, where the second character size is different than the first character size. For example, a first instance 744 of “a” may be sized differently than a second instance 746 of “a” although the characters are the same.

A indent size variance may be used to vary indent sizes or indent lengths of lines of text within a single conversion, or between multiple conversions. To generate an indent size variance, in one example, certain embodiments may determine that the digital text has a first line and a second line, determine a first indent size for the first line, and may determine a second indent size for the second line, where the second indent size is different than the first indent size.

A distinguishing feature of the writing machine may be the ability to reciprocate and/or retrace a path immediately after completing the path (e.g., continuously going back and forth over a line without waiting for ink to dry, etc.). For example, the one or more paths may include a third path at the second line. The writing machine may determine that the third path is the same as the second path, but that a first direction of the third path is opposite a second direction of the second path, such that the writing device will retrace the path in the opposite direction. The writing device may move the object holder or the writing instrument carrier along the third path after completing the second path.

In the example of FIG. 7, the word “better” 750 may be written in cursive, and may be formed by following a first path 760 and a second path 770, where a portion of the first path 760 and the second path 770 overlap to form a “t” 780. The writing device may follow the first path 760 and the second path 770 immediately after each other, without waiting for ink to dry. In other words, the writing device may write the word “better” in the same sequence or with the same appearance that the user for whom the digital handwriting file was generated would write the word “better.”

In some embodiments, the systems and methods receive or otherwise access user input, such as handwriting samples provided by the user, and perform various processes to generate a style or font that represents the user input handwriting sample, and/or generate a render (e.g., a message rendered in the generated style or font) to be sent to one or more handwriting machines for mechanical/physical rendering.

In one example, a card generation system receives handwriting input from a user, such as a sample of handwriting. The sample input form may include a traced input form, which includes example handwriting (e.g., every letter of the alphabet, every number from 0-9, pre-determined words or phrases, or other directed input). The traced input form may be an input form that is traced manually, for example by a human digitally tracing the characters provided in the sample, or that is traced automatically, such as via optical character recognition and related software, processing. The card generation system generates a font file that represents the user handwriting style. For example, the card generation system may extract path data or other vector data from various portions of the sample input, which is validated (e.g., either manually by a human or via an automated optical process, etc.) and parsed into components that form the basis of a unified font object (UFO), or font file. The card generation system generates a render template or message based on the generated font file. For example, the card generation system may pass an encoded string of digital input to a layout engine that lays out glyphs having a selected style or font, generate path data from a canvas on which the glyph layout is set, generates gcode and svg data for the glyph layout and canvas, and converts the data into a gcode file to be transferred to a handwriting machine for rendering. The gcode file may include coordinate data that can be used by the handwriting machine or writing device to move one or more components to specific locations.

In some embodiments, a handwriting sample is received or otherwise accessed by the card generation system. The card generation system creates a font file that provides information association identifying letter fonts (e.g., a path to be drawn), spacing between letters, a baseline of text, and so on. Using the font file, the card generation system generates a render file (in gcode), which is transferred to the machine server, which controls operations of the one or inure handwriting machines.

Therefore, in some embodiments, the card generation system accesses a digital version of a handwriting sample provided by a user, generates a font file that represents a handwriting style determined for the user, where the font file includes information associated with paths followed by a mechanical rendering implement when rendering letters in the handwriting style, information associated with a spacing between letters in the handwriting style, and/or information associated with a baseline layout of letters in the handwriting style, generates a rendered message that is based on the handwriting style determined for the user and text provided by the user and convers the generated rendered message into a machine-readable format, and provides the machine-readable format of the rendered message to a mechanical rendering machine.

Some embodiments include a writing system as a three-axis gantry robot that operates a pen. It includes an instrument holder that traces a pattern out on the X-Y frame or phase and then has a Z component, which is putting the pen down and provides pen pressure as it traces out the X-Y pattern, which is the script to be written. The Z component may be tied to the X component. The instrument holder is capable of reversing its trajectory in the manner that a human being writes. In the system, the instrument and other flying or moving components are weight-reduced, allowing the system to achieve a high speed. For example, the X and Y components are separate but move in a coordinated fashion. Therefore, the system could achieve a higher speed than a machine where the X and Y components move together. The system also achieves a high accuracy than merely moving the X and Y components separately by having the two components move in a coordinated fashion.

In addition, the instrument holder maintains this high accuracy throughout the course of its movement, as every part of every word counts in the writing process. Furthermore, the instrument holder manages the frictions that come in different forms depending on the font style, the paper quality, etc. For example, different types of pens have different frictional properties. For instance a roller ball will roll, whereas a parallel plate pen with glide. A plastic nib pen will also glide but will be stickier than a metal nib pen. This grips the paper. If the paper is textured, a roller ball's diameter will greatly affect the friction as it tries to roll over what amounts to a rough landscape. Ink viscosity is also a factor, as liquid inks create a boundary layer of low friction as the flow onto the paper. By contrast, gel inks are designed to stick to the paper and create a layer that quickly turns to an adhesive. The machine may handle all forms of pen, so to allow for this the pen holder has been designed with a certain flexibility in the Z axis to allow for vertical movement to lessen or increase friction via pressure changes. Additionally the holder itself is a tuned mechanism designed to absorb sticking and break-free of the pen with minimal impact to the script, and with no damage to the pen. Additionally the energy continually put into the pen through friction events is absorbed and dissipated within the tool holder's polymer material.

The instrument holder also handles the vibrations that ensue from the fast movement and need to reverse trajectory. Specifically, the system uses a steel-based tool belt to index the motors to the moving parts. Being able to stretch a little, these belts allow the system to accelerate from zero to the maximum speed very quickly without breaking or over-stretching.

For example, belts are tensioned by a deflection distance method. The steel belt allows for this to tolerate a wide range of tensions and still be successful. We have also used tensioning springs installed on the belt itself but we have not made that part of the standard, precisely because it has not been necessary. The steel allows us to operate at higher tensions overall, so it is not as critical a factor as when using fiberglass-reinforced belts.

The system further employs a specific set of torque specifications to grab the sliding mechanisms together so that they cannot vibrate but are free enough to move quickly. In addition, the system increases the weights of certain flying pieces, to further damp any squiggle that remain from the vibration impact. Masses close to the pen are increased to provide inertia there. While the full assembly is made lightweight for speed, within the assembly, the weight is not evenly distributed. It is tuned to provide most of the energy dissipation at the critical points. This means that vibration is asymmetrically averaged over the assembly. A vibration might be larger at the far end of the assembly, but that does not matter, it is the pen tip that is tuned. The system also channels more electrical energy into accelerating these weights and optimizes the total mass of the flying piece so that they still move as fast as possible.

In general, the system adapts to the particular situation and optimizes the overall effect of different factors accordingly. Different situations can result from different types of handwriting styles. For example, for a small tight handwriting, Where the glyphs are an eighth of an inch tall, such as a very, 19th century European style script, the reversals are very fast, but the overall velocity remains relatively low because there is not any long line to coast all the way up to that speed and back. In this case, the system focuses on improving handling reversals and wiggling and jiggling. On the other hand, for big writing, where the glyphs are half an inch tall in a paragraph style and everything is long and sweeping, there are very few reversals comparatively, but the maximum speed could be high.

Certain embodiments may include a method that includes operations of accessing a digital version of a handwriting sample provided by a user, and generating a font file that represents a handwriting style determined for the user The font file may include information associated with paths followed by a mechanical rendering implement when rendering letters in the handwriting style, information associated with a spacing between letters in the handwriting style, and/or information associated with a baseline layout of letters in the handwriting style. The method may include generating a rendered message that is based on the handwriting style determined for the user and text provided by the user, converting the generated rendered message into a machine-readable format, and providing the machine-readable format of the rendered message to a mechanical rendering machine.

Certain embodiments may include a system for outputting script on an object that includes a motor-based instrument holder. The motor-based instrument holder may include an x-component, a y-component, and a z-component, a belt that controls the movement of the instrument holder in accordance with a torque specification, a motor-based object gripper that has a slotted construct, a platen, and a bottom frame to which some or all other elements of the system are attached, including an electrical board. When subjected to electrostatic force, the object gripper may move an object from a first location towards the platen before inscription on the object, and move the object away from the platen to a second location after the inscription. When subjected to the electrostatic force, the platen may hold on to the object during the inscription, and the x- and y-components may move separately but in a coordinated fashion, and the z-component can inscribes a script in one of a plurality of styles on the object during the inscription.

Certain embodiments may use high voltage to hold a piece of paper. While the paper is fairly non-conductive, there is ionic water from air humidity in the paper that could react to the high the voltage. Through experimentation, by applying a voltage differential of 7,000 volts, for example, the system can grip a piece of paper reliably. Since that operation takes almost no current, the energy cost goes to practically zero. The operation is also completely silent. Furthermore, while a piece of paper may have a flat shape, it can be in a curved configuration sometimes. The system contains specially-shaped electrodes that do not assume that the object (piece of paper) to be gripped is completely flat are able to generally achieve full-surface contact with the object.

In some embodiments, the gripper is sectioned into narrow parallel “fingers”, each of which is sufficiently flexible to conform to a slightly convex or concave surface. The fingers move independently so complex combinations of adjacent convexity and concavity are possible. Certain embodiments may load objects or paper through an electrostatic force mechanism. The system includes small electrostatic gripper and a platen. In general, the gripper goes down onto a stack of paper and use electrostatic force to pull the top piece of paper off of the stack. It typically grips only pulls one piece of paper, as the electrostatic force concentrates on the outer layer of molecules of which the paper is made, and there's little electrical penetration into the layers below. At that point, the paper is in full sight of the ground below it and simply holding its weight up in the air. The system moves the platen underneath this gripper and then pushes the gripper down so that the piece of paper is now clamped between two electrostatic surfaces. Then the platen energizes, the gripper de-energizes, and the paper is now sucked down with gravity and electrostatic force to the platen which pulls it flat, which is conducive to a uniform pen pressure and a predictable look of writing. The gripper may have a slotted construct, where each slot is a kind of a bridge, similar to a rope bridge that hangs down. It is slotted enough that when the electrostatic force is applied to that top page and that top page is not flat, the gripper would clamp itself down and morph to the surface shape of that piece of paper, thereby developing the maximum gripping force. In other words, the gripper has these “fingers” effectively so that it could morph itself to the surface get that maximum surface area, suspend the weight of the entire paper, bring it to the platen, and it pushes the paper down into the platen which then further pushes it down with its own electrostatic force to flatten it out and make the object or the substrate as flat as possible.

Then the gripper de-energizes and retracts. It is the opposite procedure for picking paper up all flattened. Initially, both sides of the paper are energized so they are both being grabbed. Subsequently, the electrostatic force on the platen turns off and then the paper could go in the direction of the gripper that is still energized or gets unloaded that way.

One or more operations of the method, process flows, or use cases of FIGS. 1-7 may have been described above as being performed by a user device, or more specifically, by one or more program module(s), applications, or the like executing on a device. It should be appreciated, however, that any of the operations of the methods, process flows, or use cases of FIGS. 1-7 may be performed, at least in part, in a distributed manner by one or more other devices, or more specifically, by one or more program module(s), applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-7 may be described in the context of the illustrative devices, it should be appreciated that such operations may be implemented in connection with numerous other device configurations.

The operations described and depicted in the illustrative methods, process flows, and use cases of FIGS. 1-7 may be carried out or performed in any suitable order, such as the depicted orders, as desired in various example embodiments of the disclosure. Additionally, in certain example embodiments, at least a portion of the operations may be carried out in parallel. Furthermore, in certain example embodiments, less, more, or different operations than those depicted in FIGS. 1-7 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to he performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Computer Architecture

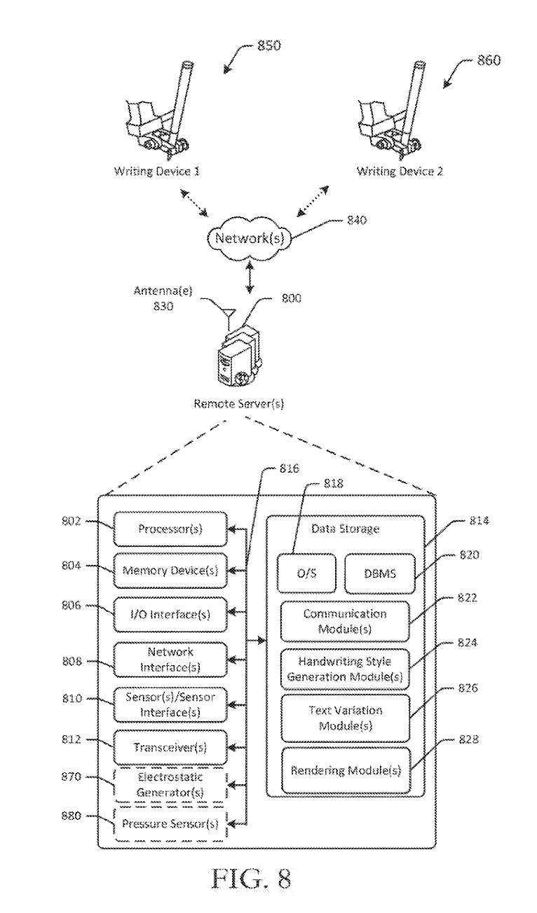

FIG. 8 is a schematic block diagram of one or more illustrative remote server(s) 800 in accordance with one or more example embodiments of the disclosure. The remote server(s) 800 may include any suitable computing device including, but not limited to, a server system, a mobile device such as a smartphone, a tablet, an e-reader, a wearable device, or the like; a desktop computer; a laptop computer; a content streaming device; a set-top box; or the like. The remote server(s) 800 may correspond to an illustrative device configuration for the digital text conversion server(s) of FIGS. 1-7.

The remote server(s) 800 may be configured to communicate via one or more networks with one or more servers, user devices, or the like. The remote server(s) 800 may be configured to manage, implement, instruct, and/or control writing devices, generate handwriting styles, manage conversion of digital text, and the like. The remote server(s) 800 may be configured to deliver instructions and/or data and may further be configured to control connected writing devices. In some embodiments, a single remote server or single group of remote servers may be configured to perform more than one type of digital text conversion functionality.

The remote server(s) 800 may be configured to communicate via one or more networks 840. Such network(s) 840 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) 840 may have any suitable communication range associated therewith and may include, for example, global networks (e.g., the Internet), metropolitan area networks (MANs), wide area networks (WANs), local area networks (LANs), or personal area networks (PANS). In addition, such network(s) 840 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In FIG. 8, the remote server(s) 800 may communicate with one or more writing devices via the network(s) 840. For example, the remote server(s) 800 may communicate with a first writing device 850 via the network(s) 840. Likewise, the remote server(s) 800 may communicate with a second writing device 860 via the network(s) 840. The remote server(s) 800 may communicate with any number of writing devices.

In an illustrative configuration, the remote server(s) 800 may include one or more processors (processor(s)) 802, one or more memory devices 804 (generically referred to herein as memory 804), one or more input/output (“I/O”) interface(s) 806, one or more network interface(s) 808, one or more sensors or sensor interface(s) 810, one or more transceivers 812, and data storage 814. The remote server(s) 800 may further include one or more buses 816 that functionally couple various components of the remote server(s) 800. The remote server(s) 800 may further include one or more antenna(e) 830 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 816 may include at least one of a system bus, a memory bus, an address bus, or a message bus, and may permit the exchange of information (e.g., data (including computer-executable code), signaling, etc.) between various components of the remote server(s) 800. The bus(es) 816 may include, without limitation, a memory bus or a memory controller, a peripheral bus, an accelerated graphics port, and so forth. The bus(es) 816 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 804 of the remote server(s) 800 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 804 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 804 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 814 may include removable storage and/or non-removable storage including, but not limited to, magnetic storage, optical disk storage, and/or tape storage. The data storage 814 may provide non-volatile storage of computer-executable instructions and other data. The memory 804 and the data storage 814, removable and/or non-removable, are examples of computer-readable storage media (CRSM) as that term is used herein.

The data storage 814 may store muter-executable code, instructions, or the like that may be loadable into the memory 804 and executable by the processor(s) 802 to cause the processor(s) 802 to perform or initiate various operations. The data storage 814 may additionally store data that may be copied to the memory 804 for use by the processor(s) 802 during the execution of the computer-executable instructions. Moreover, output data. generated as a result of execution of the computer-executable instructions by the processor(s) 802 may be stored initially in the memory 804, and may ultimately be copied to data storage 814 for non-volatile storage.

More specifically, the data storage 814 may store one or more operating systems (O/S) 818; one or more database management systems (DBMS) 820; and one or more program module(s), applications, engines, computer-executable code, scripts, or the like such as, for example, one or more communication module(s) 822, one or more handwriting style generation module(s) 824, one or more text variation module(s) 826, and/or one or more rendering module(s) 828. Some or all of these module(s) may be or include sub-module(s). Any of the components depicted as being stored in data storage 814 may include any combination of software, firmware, and/or hardware. The software and/or firmware may include computer-executable code, instructions, or the like that may be loaded into the memory 804 for execution by one or more of the processor(s) 802. Any of the components depicted as being stored in data storage 814 may support the functionality described in reference to the corresponding components named earlier in this disclosure.

The data storage 814 may further store various types of data utilized by the components of the remote server(s) 800. Any data stored in the data storage 814 may be loaded into the memory 804 for use by the processor(s) 802 in executing computer-executable code. In addition, any data depicted as being stored in the data storage 814 may potentially be stored in one or more datastore(s) and may be accessed via the DBMS 820 and loaded in the memory 804 for use by the processor(s) 802 in executing computer-executable code. The datastore(s) may include, but are not limited to, databases (e.g., relational, object-oriented, etc.), file systems, flat files, distributed datastores in which data is stored on more than one node of a computer network, peer-to-peer network datastores, or the like. In FIG. 8, an example datastore(s) may include, for example, font files, user preferences, contact information, stationery selection data, and other information.

The processor(s) 802 may be configured to access the memory 804 and execute computer-executable instructions loaded therein. For example, the processor(s) 802 may be configured to execute computer-executable instructions of the various program module(s), applications, engines, or the like of the remote server(s) 800 to cause or facilitate various operations to be performed in accordance with one or more embodiments of the disclosure. The processor(s) 802 may include any suitable processing unit capable of accepting data as input, processing the input data in accordance with stored computer-executable instructions, and generating output data. The processor(s) 802 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 802 may have any suitable microarchitecture design that includes any number of constituent components such as, for example, registers, multiplexers, arithmetic logic units, cache controllers for controlling react/write operations to cache memory, branch predictors, or the like. The microarchitecture design of the processor(s) 802 may be capable of supporting any of a variety of instruction sets.

Referring now to functionality supported by the various program module(s) depicted in FIG. 8, the communication module(s) 822 may include computer-executable instructions, code, or the like that responsive to execution by one or more of the processor(s) 802 may perform functions including, but not limited to, communicating with remote servers, communicating with remote datastores, communicating with writing devices, determining which writing device to communicate with, sending or receiving information and instructions, and the like.

The handwriting style generation module(s) 824 may include computer-executable instructions, code, or the like that responsive to execution by one or more of the processor(s) 802 may perform functions including, but not limited to, analyzing writing samples, generating handwriting data files, generating font files, categorizing handwriting, and the like.

The text variation module(s) 826 may include computer-executable instructions, code, or the like that responsive to execution by one or more of the processor(s) 802 may perform functions including, but not limited to, selecting glyphs, determining character or glyph size, applying various handwriting variations, controlling operations at writing devices, and the like.

The rendering module(s) 828 may include computer-executable instructions, code, or the like that responsive to execution by one or more of the processor(s) 802 may perform functions including, but not limited to, generate renderings of converted physical text, determining whether renderings are approved, adjusting renderings, and the like.

Referring now to other illustrative components depicted as being stored in the data storage 814, the O/S 818 may be loaded from the data storage 814 into the memory 804 and may provide an interface between other application software executing on the remote server(s) 800 and the hardware resources of the remote server(s) 800. More specifically, the O/S 818 may include a set of computer-executable instructions for managing the hardware resources of the remote server(s) 800 and for providing common services to other application programs (e.g., managing memory allocation among various application programs). In certain example embodiments, the O/S 818 may control execution of the other program module(s) to dynamically enhance characters for content rendering. The O/S 818 may include any operating system now known or which may be developed in the future including, but not limited to, any server operating system, any mainframe operating system, or any other proprietary or non-proprietary operating system.

The DBMS 820 may be loaded into the memory 804 and may support functionality for accessing, retrieving, storing, and/or manipulating data stored in the memory 804 and/or data stored in the data storage 814. The DBMS 820 may use any of a variety of database models (e.g., relational model, object model, etc.) and may support any of a variety of query languages. The DBMS 820 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like. In those example embodiments in which the remote server(s) 800 is a mobile device, the DBMS 820 may be any suitable light-weight DBMS optimized for performance on a mobile device.

Referring now to other illustrative components of the remote server(s) 800, the input/output (I/O) interface(s) 806 may facilitate the receipt of input information by the remote server(s) 800 from one or more I/O devices as well as the output of information from the remote server(s) 800 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the remote server(s) 800 or may be separate. The I/O devices may further include, for example, any number of peripheral devices such as data storage devices, printing devices, and so forth.

The I/O interface(s) 806 may also include an interface for an external peripheral device connection such as universal serial bus (USB), FireWire, Thunderbolt, Ethernet port or other connection protocol that may connect to one or more networks. The I/O interface(s) 806 may also include a connection to one or more of the antenna(e) 830 to connect to one or more networks via a wireless local area network (WAN) (such as Wi-Fi) radio, Bluetooth, and/or a wireless network radio, such as a radio capable of communication with a wireless communication network such as a Long Term Evolution (LTE) network, a WiMAX network, a 3G network, etc.

The remote server(s) 800 may further include one or more network interface(s) 808 via which the remote server(s) 800 may communicate with any of a variety of other systems, platforms, networks, devices, and so forth. The network interface(s) 808 may enable communication, for example, with one or more wireless routers, one or more host servers, one or more web servers, and the like via one or more of networks.

The antenna(e) 830 may include any suitable type of antenna depending, for example, on the communications protocols used to transmit or receive signals via the antenna(e) 830. Non-limiting examples of suitable antennae may include directional antennae, non-directional antennae, dipole antennae, folded dipole antennae, patch antennae, multiple-input multiple-output (MIMO) antennae, or the like. The antenna(e) 830 may be communicatively coupled to one or more transceivers 812 or radio components to which or from which signals may be transmitted or received.

As previously described, the antenna(e) 830 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(e) 830 may additionally, or alternatively, include a Wi-Ti antenna configured to transmit or receive signals in accordance with established standards and protocols, such as the IEEE 1002.11 family of standards, including via 2.4 GHz channels (e.g. 1002.11b, 1002.11g, 1002.11n), 5 GHz channels (e.g. 1002.11n, 1002.11ac), or 60 GHz channels (e.g. 1002.11ad). In alternative example embodiments, the antenna(e) 830 may be configured to transmit or receive radio frequency signals within any suitable frequency range forming part of the unlicensed portion of the radio spectrum.

The antenna(e) 830 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 812 may include any suitable radio component(s) for—in cooperation with the antenna(e) 830—transmitting or receiving radio frequency (RF) signals in the bandwidth and/or channels corresponding to the communications protocols utilized by the remote server(s) 800 to communicate with other devices. The transceiver(s) 812 may include hardware, software, and/or firmware for modulating, transmitting, or receiving—potentially in cooperation with any of antenna(e) 830—communications signals according to any of the communications protocols discussed above including, but riot limited to, one or more Wi-Fi and/or Wi-Fi direct protocols, as standardized by the IEEE 1002.11 standards, one or more non-Wi-Fi protocols, or one or more cellular communications protocols or standards. The transceiver(s) 812 may further include hardware, firmware, or software for receiving GNSS signals. The transceiver(s) 812 may include any known receiver and baseband suitable for communicating via the communications protocols utilized by the remote server(s) 800. The transceiver(s) 812 may further include a low noise amplifier (LNA), additional signal amplifiers, an analog-to-digital (A/D) converter, one or more buffers, a digital baseband, or the like.

The sensor(s)/sensor interface(s) 810 may include or may be capable of interfacing with any suitable type of sensing device such as, for example, inertial sensors, force sensors, thermal sensors, and so forth. Example types of inertial sensors may include accelerometers (e.g., MEMS-based accelerometers), gyroscopes, and so forth. One or more pressure sensors 880 may be included and used to determine or detect pressure, for example, between a writing instrument and an object holder. One or more electrostatic generators may be used to, for example, generate an electrostatic charge at an object holder.

It should be appreciated that the program module(s), applications, computer-executable instructions, code, or the like depicted in FIG. 8 as being stored in the data storage 814 are merely illustrative and not exhaustive and that the processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the remote server(s) 800, and/or hosted on other computing device(s) accessible via one or more networks, may be provided to support the functionality provided by the program module(s), applications, or computer-executable code depicted in FIG. 8 and/or additional or alternate functionality. Further, functionality may be modularized differently such that processing described as being supported collectively by the collection of program module(s) depicted in FIG. 8 may be performed by a fewer or greater number of module(s), or functionality described as being supported by any particular module may be supported, at least in part, by another module. In addition, program module(s) that support the functionality described herein may form part of one or more applications executable across any number of systems of devices in accordance with any suitable computing model such as, for example, a client-server model, a peer-to-peer model, and so forth. In addition, any of the functionality described as being supported by any of the program module(s) depicted in FIG. 8 may be implemented, at least partially, in hardware and/or firmware across any number of devices.

It should further be appreciated that the remote server(s) 800 may include alternate and/or additional hardware, software, or firmware components beyond those described or depicted without departing from the scope of the disclosure. More particularly, it should be appreciated that software, firmware, or hardware components depicted as forming part of the remote server(s) 800 are merely illustrative and that some components may not be present or additional components may be provided in various embodiments. While various illustrative program module(s) have been depicted and described as software module(s) stored in the data storage 814, it should be appreciated that the functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

One or more operations of the methods, process flows, and use cases of FIGS. 1-7 may be performed by a device having the illustrative configuration depicted in FIG. 8, or more specifically, by one or more engines, program module(s), applications, or the like executable on such a device. It should be appreciated, however, that such operations may be implemented in connection with numerous other device configurations.

The operations described and. depicted in the illustrative methods and process flows of FIGS. 1-7 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-7 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any or a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A mechanical drawing apparatus comprising:
an object holder configured to receive an object comprising a writing surface, wherein the object holder is configured to move the object in one or more directions;
a writing instrument comprising a writing tip at an end of the writing instrument, wherein the writing tip is configured to write on the writing surface;
a writing instrument carrier configured to move in at least two directions, wherein the writing instrument is positioned in the writing instrument carrier; and
a controller configured to:
receive path instructions comprising a plurality of paths about which to move the object holder or the writing instrument carrier, wherein the plurality of paths comprises a first path at a first line and a second path at a second line;
identify a first starting location of the first line at the writing surface;
determine that the writing tip is in contact with the writing surface;
move the object holder or the writing instrument carrier along the first path;
move the object holder or the writing instrument to create a gap between the writing tip and the writing surface;
identify a second starting location of the second line;
determine that the writing tip is in contact with the writing surface; and
move the object holder or the writing instrument carrier along the second path.

2. The mechanical drawing apparatus of claim 1, further comprising:
a pressure sensor positioned at the object holder, the pressure sensor configured to detect a pressure between the writing tip and the object holder;
wherein the controller is further configured to:
determine that a first pressure value between the writing tip and the object holder is less than a predetermined pressure value;
adjust a first position of the writing instrument carrier or a second position of the object holder; and
determine that a second pressure value between the writing tip and the object holder is substantially equal to the predetermined pressure value.

3. The mechanical drawing apparatus of claim 1, wherein the plurality of paths further comprises a third path at the second line, and wherein the controller is further configured to:
determine that the third path is the same as the second path;
determine that a first direction of the third path is opposite a second direction of the second path; and
move the object holder or the writing instrument carrier along the third path after completing the second path.

4. The mechanical drawing apparatus of claim 1, wherein:
the writing instrument carrier is configured to move along two axes; and
the object holder is configured to move the object along a single axis that is perpendicular to the two axes.

5. The mechanical drawing apparatus of claim 1, wherein:
the object holder is configured to move the object along two axes; and
the writing instrument carrier is configured to move along a single axis that is perpendicular to the two axes.

6. A method comprising:
determining, by one or more computer processors coupled to at least one memory, a digital handwriting file comprising a set of one or more digital characters, wherein a first digital character of the set of one or more digital characters comprises a first glyph and a second glyph;
receiving digital text comprising a set of characters for conversion to physically written text, wherein the set of characters comprises a first instance of a first character corresponding to the first digital character and a second instance of the first character;
selecting the second glyph for a first physically written conversion of the first instance of the first character;
selecting the first glyph for a second physically written conversion of the second instance of the first character; and
causing conversion of the digital text.

7. The method of claim 6, further comprising:
determining that the digital text comprises first text on a first line, second text on a second line, and third text on a third line;
adjusting a first distance between respective baselines of the first line, the second line, and the third line, such that a first distance between a first baseline of the first line and a second baseline of the second line is different than a second distance between the second baseline of the second line and a third baseline of the third line.

8. The method of claim 6, further comprising:
determining that the digital text comprises a first instance of a second character adjacent to the first instance of the first character;
determining that the digital text comprising a second instance of the second character adjacent to the second instance of the first character; and
adjusting a distance between the respective instances of the first character and the second character, such that a first distance between the first instance of a second character and the first instance of the first character is different than a second distance between the second instance of the second character and the second instance of the first character.

9. The method of claim 6, further comprising:
determining that the first instance of the first character and the second instance of the second character are on a first line; and
adjusting a distance between bottoms of the respective instance of the first character and a baseline of the first line, such that a first distance between a first bottom of the first instance is different than a second distance between a second bottom of the second instance.

10. The method of claim 6, further comprising:
determining that the digital text comprises a first line and a second line; and
adjusting a line skew amplitude of the first line and the second line, such that a first line skew amplitude of the first line is different than a second line skew amplitude of the second line.

11. The method of claim 6, further comprising:
receiving a selection of the digital handwriting file;
generating path information for one or more of the set of characters; and
sending the path information to a writing device for the conversion of the digital text to the physically written text.

12. The method of claim 6, further comprising:
generating the digital handwriting file based at least in part on manually generated trace data.

13. The method of claim 6, further comprising:
generating the digital handwriting file based at least in part on automatically generated trace data, wherein the trace data is generated using optical character recognition.

14. The method of claim 6, further comprising:
determining that the digital text comprises a first line and a second line; and
adjusting a line waver frequency of the first line and the second line, such that a first line waver frequency of the first line is different than a second waver frequency of the second line.

15. The method of claim 6, further comprising:
determining a first character size for the second glyph;
determining a second character size for the first glyph, wherein the second character size is different than the first character size.

16. The method of claim 6, further comprising:
determining that the digital text comprises a first line and a second line;
determining a first indent size for the first line;
determining a second indent size for the second line, wherein the second indent size is different than the first indent size.

17. A method comprising:
receiving, by one or more computer processors coupled to at least one memory, digital text comprising a set of characters for conversion to physically written text, wherein the set of characters comprises a first instance of a first character;
determining a digital handwriting file for a style of the physically written text, the digital handwriting file comprising a first glyph and a second glyph of a first digital character corresponding to the first character;
randomly selecting the first glyph or the second glyph for the first instance of the first character;
generating path information for conversion of the digital text to physically written text based at least in part on the randomly selected glyph;
causing a first conversion of the digital text; and
causing a second conversion of the digital text.

18. The method of claim 17, wherein the first conversion is from digital text to first physically written content and the second conversion is from digital text to second physically written content, and wherein the first physically written text is different than the second physically written text.

19. The method of claim 17, wherein causing the first conversion of the digital text comprises:
causing the first conversion of the digital text to first physically written text at a writing device that uses a pen.

20. The method of claim 17, wherein the digital text is received in a text message, spreadsheet, or email message; and
wherein the first conversion is at a first writing device and the second conversion is at a second writing device.
